(19) United States
(12) Patent Application Publication
(10) Pub. No.: US 2007/0173243 A1
(43) Pub. Date: Jul. 26, 2007

(54) Method for communicating by means of a plurality of network-side transmission antennas

(76) Inventor: Hui Li, Beijing (CN)

Correspondence Address: STAAS & HALSEY LLP, SUITE 700, 1201 NEW YORK AVENUE, N.W., WASHINGTON, DC, 20005, US

(21) Appl. No.: 10/589,888

(22) PCT Filed: Dec. 23, 2004
(86) PCT No.: PCT/EP04/53686

§ 371 Date: Aug. 18, 2006

(30) Foreign Application Priority Data
Feb. 18, 2004 (EP) 04003631.1

(51) Int. Cl. H04Q 7/20

(52) U.S. Cl. 455/422.1

(57) ABSTRACT

A method communicates through a radio communications system having network side devices and radio stations. A message from the radio station is received by the network side antennas. Subsequently, a useful data message is transmitted to the radio station by transmitting network side antennas. The transmitting network side antennas received the message from the radio station.

### CROSS REFERENCE TO RELATED APPLICATIONS

This application is based on and hereby claims priority to PCT Application No. PCT/EP2004/053686 filed on Dec. 23, 2004 and European Application No. EP04003631 filed on Feb. 18, 2004, the contents of which are hereby incorporated by reference.

### BACKGROUND OF THE INVENTION

The invention relates to a method for communication in a radio communications system. Furthermore the invention relates to a network-side device and a computer program for executing the method.

In radio communications systems messages such as signaling messages or user data messages with speech information, picture information, video information, SMS (Short Message Service), MMS (Multimedia Messaging Service) or other data for example, are transmitted with the aid of electromagnetic waves over a radio interface between transmitting and receiving station. The stations can in this case, depending on the concrete embodiment of the radio communications system, involve diverse types of subscriber-side mobile stations and network-side radio devices. In a mobile radio communications system at least one part of the subscriber-side radio stations is mobile radio stations. The electromagnetic waves are emitted with carrier frequencies which lie in the frequency band provided for the relevant system.

Mobile radio communications systems are often embodied as cellular systems in accordance with the GSM (Global System for Mobile Communication) or UMTS (Universal Mobile Telecommunications System) standard with network-side devices such as base stations and devices for checking and controlling the base stations.

As well as these cellular, hierarchical radio networks organized on a wide-area (supralocal) basis, there are also Wireless Local Area Networks (WLANs) with a radio coverage area that as a rule is far more limited. The cells covered by the radio access points (AP) of the WLANs, with a radius of up to a few hundred meters, are small by comparison with usual mobile radio cells. Examples of different standards for WLANs are HiperLAN, DECT, IEEE 802.11, Bluetooth and WATM.

Document 01/18991 A1 describes a cellular CDMA radio communications system. The base stations measure the signal-to-noise ratio of signals, which are sent by mobile stations in the uplink direction. Depending on these measurement results, one or more uplink radio channels are determined for the communication of the relevant mobile station.

Document 02/27972 A2 describes a radio communications system in which the base stations feature a number of antenna elements. If a base station initiates communication with a subscriber station, it sends a paging message. The paging message can be transmitted on one channel which also contains data transmissions to other user stations. To this end signals which the base station receives from the other user stations are used to determine the smart antenna activation for the paging signal.

Whereas in many radio communications systems a series of network-side antennas, as a rule arranged centrally per cell, is used for transmission of messages to mobile stations, it is also possible to use a plurality of network-side antennas. Messages for mobile stations can then be emitted simultaneously via a plurality of network-side antennas. If a message is emitted to a mobile station via a plurality of network-side antennas, this sometimes causes disturbing interference for message transmission to other mobile stations located in the vicinity. It is thus advantageous to only emit messages for a mobile station via a restricted number of network-side antennas.

### SUMMARY OF THE INVENTION

One possible object of the invention is to present an efficient method for communication in which a message is sent via a plurality of network-side antennas to a mobile station. Furthermore a network-side device and a computer program for a network-side device for executing the method are to be proposed.

The inventor proposes a method is employed in a radio communications system which comprises network-side devices and mobile stations. A message of a mobile station is received by network-side antennas. Subsequently a user data message is transmitted via a plurality of network-side antennas to the mobile station. The invention the association between the network-side antennas and the plurality of network-side antennas depends on the network-side antennas which have received the message of the mobile station. The message received on the network side involves a response message sent on receipt of a signaling message. The signaling message requests the mobile station to send a response message and is transmitted via at least one network-side antenna to the mobile station.

The network-side devices of the radio communications system can for example be network-side antennas, devices for control of the antennas and devices for creating messages to be transmitted and for processing received messages. The mobile stations can comprise different types of, especially mobile, user stations. By preference the radio communications system can involve a cellular system, with each radio cell featuring one or more network-side antennas. With a number of network-side antennas per radio cell all network-side antennas of the relevant radio cell are connected to a network-side device which transmits to the network-side antennas messages to be emitted. Network-side antennas of various radio cells receive the messages to be emitted by them from different network-side devices.

The message of the mobile station, on the basis of the reception of which a decision can be made on the network side about the network-side antennas via which a user data message to be transmitted in the future is to be transmitted to the mobile station, can in particular include identification information of the mobile station. After the evaluation of the network-side antennas via which the message of the mobile station was received, a user data message is sent to the mobile station via a plurality of antennas. The composition of the plurality of network-side antennas, i.e. the question of which network-side antennas make up the plurality of network-side antennas, can be defined so that all those network-side antennas which have received the message of the mobile station or have received it with a minimum receive level, send the user data message to the mobile station. However in addition to the criterion covering which network-side antennas have received the message of the mobile station, further criteria for defining the plurality of network-side antennas can be used, such as a minimum or a highest number of network-side antennas to be used, a utilization of network-side antennas and/or a geographical or cell-related distribution or arrangement of the network-side antennas.

It is advantageous for the network-side antennas of the plurality of network-side antennas to be located at different positions within of the radio communications system, i.e. to be separated by distances which are large in relation to the wavelength used for radio transmission. In a cellular system for example the network-side antennas of a cell can be distributed approximately evenly over the cell. Preferably the user data message is transmitted to the mobile station over the plurality of network-side antennas with synchronous or at least approximately synchronous timing or with network-side defined time differences between the transmission of the user data message via the individual network-side antennas.

It is advantageous if the signaling message is transmitted via a group of network-side antennas, with this group comprising the plurality of network-side antennas via which the user data message will subsequently be sent to the mobile station. The signaling message can especially include identification information of the mobile station.

The mobile station is explicitly requested to transmit the message which can then be used on the network side for selection of suitable network-side antennas for transmission of messages to the mobile station. In particular it is possible for the signaling message to be transmitted exclusively for the purposes of requesting the response message.

Preferably the signaling message is transmitted at regular first time intervals. It is also possible for the signaling message to be transmitted to the mobile station before the user data message is transmitted, on the condition that a specific period of time has elapsed since the last transmission of a message of the signaling message type. The last-mentioned embodiment then makes it possible, if there is a user data message available on the network side for the mobile station, to check the last time that the network-side antennas which were to be used for transmission were determined. If this last determination was longer ago that the second time interval, a signaling message can be sent in order to define the suitable network-side antennas before the user data message is transmitted. The combination of the regular transmission of the signaling message with a transmission of the signaling message for a concrete reason, i.e. with the check as to whether the signaling message is to be transmitted before a user data message transmission, is also possible.

It is possible for the signaling message to be sent via all network-side antennas of one or more radio cells of the radio communications system or via all network-side antennas of the radio communications system. The decision about the network-side antennas via which the signaling message is sent to the mobile station can be made dependent on how precisely the current position of mobile station in the radio communications system is known.

Furthermore it is possible for the plurality of network-side antennas to belong to the same radio cell of the radio communications system, or for at least some of the network-side antennas of the plurality of network-side antennas to belong to different radio cells of the radio communications system. This enables handover processes between different radio cells to be simplified.

In a preferred embodiment the signaling message includes identification information of the relevant radio cell about the network-side antenna or antennas of which it is transmitted, and the response message comprises identification information of that radio cell or those radio cells from the network-side antenna or antennas of which the mobile station has received the signaling message. If the signaling message is emitted via network-side antennas of a plurality of radio cells, the signaling message enters different cell-specific identification information in each case in these radio cells. If the mobile station merely receives the signaling message via network-side antennas of a single radio cell, the response message contains identification information from this radio cell only. If on the other hand the mobile station receives the signaling message via network-side antennas of a first and a second radio cell, the response message contains identification information of both radio cells.

The features of the network-side device are as follows:
A receiver to receive via network-side antennas a message of a mobile station or for receiving information about the receipt via network-side antennas of a message of a mobile station, with the network-side received message involving a response message about the receipt of at least one signaling message transmitted on a network-side antenna to the mobile station (MS) requesting the mobile station to send a response message,
An instruction unit for arranging that the user data message is sent via a plurality of network-side antennas to the mobile station, and
A decision unit for determining whether network-side antennas belong to the plurality of network-side antennas, depending on which network-side antennas have received the message of the mobile station.

The network-side device can especially be implemented by a computer program. A computer program is taken to mean, as well as the actual computer program (with its technical effect extending beyond the normal physical interaction between program and processing unit) especially a computer readable medium, a collection of files, a configured processing unit, but also for example a memory device or a server, on which the file or files belonging to the computer program are stored.

The network-side device and also the computer program are especially suitable for executing the method, with this also applying to the embodiments and developments. The network-side device can also be implemented by a plurality of network-side devices connected to each other.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1: a section from a radio communications system,

FIG. 2: a first sequence diagram a method according to one embodiment of the invention,

FIG. 3: a second sequence diagram of a method according to one embodiment of the invention,

FIG. 4: a schematic diagram of the structure of a network-side control device according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

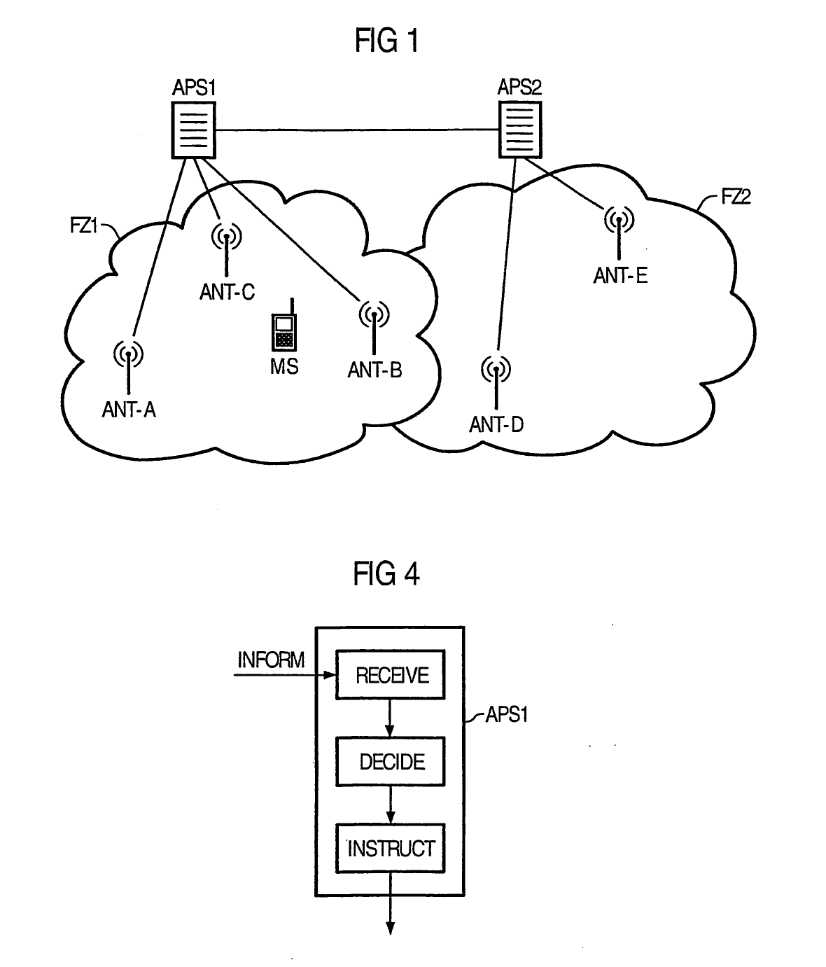

In FIG. 1 two radio cells FZ1 and FZ2 of a radio communications system are depicted by cloud symbols. Located in the first radio cell FZ1 are the three distributed network-side antennas ANT-A, ANT-B and ANT-C which are connected to the first control device APS1 (APS: Antenna Processing Station). Whereas the antennas ANT-A, ANT-B and ANT-C are responsible for receiving and transmitting messages from or to mobile stations, such as the mobile station MS for example, any processing of radio signals is undertaken in the processing station APS1. The same applies to the second radio cell FZ2, in which the two network-side antennas ANT-D and ANT-E are connected to the second processing station APS2. The two processing stations APS1 and APS2 are connected to each other via further devices if necessary. Further radio cells, infrastructure devices and subscriber-side mobile stations are not shown in FIG. 1 for reasons of clarity.

A radio cell here means the geographical area which is covered by those network-side antennas which are connected to a shared processing station. Antennas of different radio cells are thus not directly connected to the same processing station. Different radio cells can overlap with each other.

If a message is sent in a downstream direction to the mobile station MS, the transmission is undertaken simultaneously via a plurality of network-side antennas. The mobile station MS can combine the signals of the different network-side antennas and thus decode a message more reliably than by transmission via a single network-side antenna. In this case it is advantageous to only transmit a message via those antennas of which the signals can be received by the mobile station MS as a result of its current location. If antennas other than these are used, unnecessary interference for messages of other user stations is created.

In order to determine the antennas via which a message is to be transmitted to the mobile station MS, different methods are proposed. FIG. 2 shows an execution sequence of the first procedure. At the beginning the mobile station MS broadcasts a message MESSAGE which contains its identification information. The message MESSAGE is received by those antennas which are located within the radio coverage area of the mobile station MS. It is assumed that the radio coverage of the mobile station MS and that of the network-side antennas ANT-A, ANT-B, ANT-C, ANT-D and ANT-E is about the same size. FIG. 2 shows the case in which the message MESSAGE is received by the antennas ANT-A, ANT-B and ANT-C. This arrangement can for example roughly correspond to the position of the mobile station MS shown in FIG. 1. With the messages INFORM the three antennas ANT-A, ANT-B and ANT-C notify the processing station APS1 that they have received the message MESSAGE from the mobile station MS or the three antennas ANT-A, ANT-B and ANT-C forward the message MESSAGE of the mobile station MS to the processing station APS1. If there is a message DATA present on the network side for the mobile station MS, this is transmitted by the processing station APS1 to the three antennas ANT-A, ANT-B and ANT-C, which forward it to the mobile station MS.

The mobile station MS transmits the message MESSAGE unsolicited at regular time intervals T-MS. Until the next transmission of the message MESSAGE the antennas ANT-A, ANT-B and ANT-C determined for transmission as a result of the receipt of the previous message MESSAGE are used for transmitting messages to the mobile station MS. The length of the time interval between the individual transmissions of the messages MESSAGE is notified to the mobile station MS by the network. In this case account can be taken of the fact that it is advantageous, when the mobile station MS frequently receives messages, to emit the message MESSAGE at short intervals. This allows the situation to be avoided in which messages are emitted all too often via antennas which the mobile station MS cannot receive. On the other hand, for the case in which messages for the mobile station MS are only rarely present, it is better to emit the message MESSAGE at longer intervals T-MS. This enables the signaling overhead which is created by transmitting the message MESSAGE to be reduced.

FIG. 2 shows the case in which the next message MESSAGE sent by the mobile station MS is received by the antennas ANT-B, ANT-C and ANT-D. In relation to FIG. 1 this would correspond for example to the arrangement whereby the mobile station MS has moved upwards and/or to the right. The antennas ANT-B, ANT-C and ANT-D inform the processing station with the messages INFORM that they have received the message MESSAGE of the mobile station MS or the three antennas ANT-B, ANT-C and ANT-D forward the message MESSAGE of the mobile station MS to the processing station APS1. The notification of the processing station APS1 by the antenna ANT-D can be undertaken via the processing station APS2 connected to the antenna ANT-D. Alternatively it is also possible for the two antennas ANT-B and ANT-C to inform the processing station APS1 assigned to them, and the antenna ANT-D to inform the processing station APS2 assigned to it, after which the two processing stations APS1 and APS2 forward information the receipt of the message MESSAGE in their radio cells or the message MESSAGE to a shared network-side device, which then transfers to them the message DATA to be transmitted to the mobile station MS. The message DATA is then transmitted to the mobile station MS via the three antennas ANT-B, ANT-C and ANT-D.

A further procedure is shown in FIG. 3. Whereas, in FIG. 2, the mobile station MS transmits the message MESSAGE unsolicited, from the receipt of which the antennas to be used for transmission in the following messages to the mobile station MS are derived, at the beginning of the procedural sequence shown in FIG. 3 there is the transmission of a message ADR (ADR: Antenna Detection Request) to the mobile station MS, by which the mobile station MS is requested, giving its identification information, to transmit a signaling message with its identification information. The message ADR is transmitted via the three antennas ANT-A, ANT-B and ANT-C to the mobile station MS. In this case it is assumed that it is known on the network side that the mobile station MS is located in the radio cell FZ1 or at least in the immediate vicinity of the radio cell FZ1. It is however also possible to emit the message ADR via the antennas of a plurality of radio cells or via all antennas of the radio communications system.

As a reaction to the receipt of the message ADR the mobile station MS transmits the message containing its identification information ADD (ADD: Antenna Detection Done), which is received by the antennas ANT-B and ANT-C. The antennas ANT-B and ANT-C inform the processing station APS1 with the message INFORM that they have received a message ADR of the mobile station MS, or forward the message ADR of the mobile station MS to the processing station APS1. After this the message DATA is transmitted to the mobile station MS via the antennas ANT-B and ANT-C, which have received the message ADR from the mobile station MS.

The message ADR can be transmitted at regular intervals. It is however more advantageous for the message ADR to be emitted whenever there is a network-side message to the mobile station MS present. It is also possible, with the presence of a message to the mobile station MS, to check when the last message ADR was transmitted, and only to transmit a new message ADR if a specific period of time has elapsed since the last transmission.

The messages ADR can be equipped with identification information of the radio cell in which they were transmitted. If a message ADR is emitted in a number of radio cells, identification information is inserted into the message ADR in each radio cell appropriate to the radio cell concerned. If the mobile station MS then transmits a response ADD to the message ADR it inserts into the response ADD the identification information of those radio cells via the antennas of which it has received the message ADR. This is especially advantageous if the mobile station MS receives the message ADR from antennas of different radio cells. In this case it is known to the processing station of a radio cell from the evaluation of the message ADD that a mobile station can also receives antennas of other radio cells without this fact needing to be notified to the relevant processing station of by another processing station or another network-side device.

As an alternative or in addition to transmitting the messages ADR with the object of defining the antennas to be used for sending messages to the mobile station MS, the method described below which is depicted in the right-hand part of FIG. 3 can be employed. After the receipt of a message DATA the mobile station MS confirms the receipt of the message DATA by transmitting a message ACK, which comprises identification information of the mobile station MS. Those network-side antennas which have received the message ACK, in FIG. 3 the antennas ANT-B, ANT-C and ANT-D, use the message INFORM, as described above, to inform the processing station APS1 or the processing stations APS1 and APS2 about the receipt of the message ACK from the mobile station MS, or forward the message ACK from the mobile station MS to the relevant processing station APS1 or APS2. Subsequently the three antennas ANT-B, ANT-C and ANT-D are used for the next message transmission to the mobile station MS. The fact that the confirmation messages ACK of the mobile station MS are used for determining the future network-side transmit antennas means that no additional signaling overhead is involved since the confirmation messages ACK are generally transmitted independently of the method. Furthermore the described application of the confirmation messages ACK enables the optimum antennas to be determined after each transmission of a message confirmed by the mobile station MS. This results, for a frequent transmission of messages to the mobile station MS, in an ongoing application of the method.

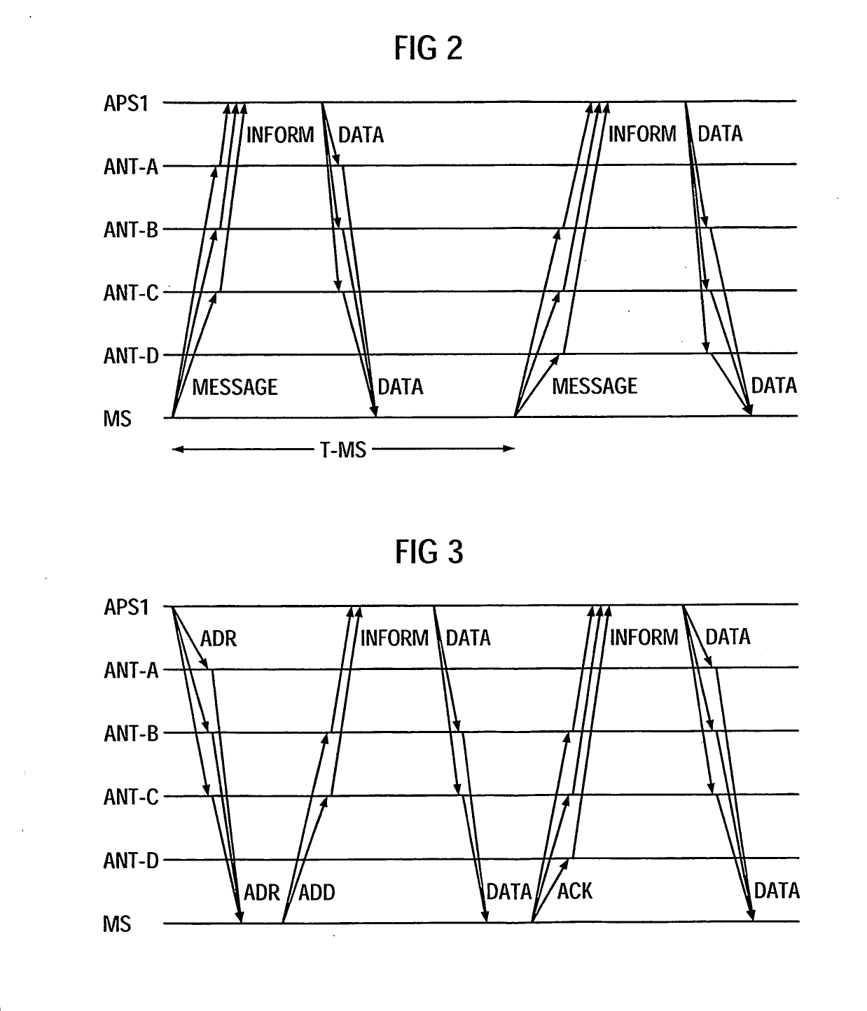

FIG. 4 shows a schematic diagram of the layout of the processing station APS1. Via the reciever RECEIVE the processing station APS1 receives the messages INFORM or the message received by network-side antennas from network-side antennas. After evaluating the messages INFORM in the decision unit DECIDE the processing station APS1 decides on the antennas via which a message transmission is subsequently to be undertaken to a mobile station. Via the instruction unit INSTRUCT the corresponding antennas defined using the decision unit DECIDE are notified that they are to transmit a message to the relevant mobile station. Accordingly a network-side device is also set up for the case in which a message is to be transmitted to a mobile station via antennas of different radio cells. The reciever RECEIVE do not then receive the messages INFORM or the messages received in the various radio cells directly from the network-side antennas, but via the processing stations assigned to the antennas concerned. In a similar way the instruction unit INSTRUCT does not communicate directly with the network-side antennas, but with the processing stations assigned to the relevant antennas.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for communication in a radio communication system comprising mobile stations and network-side devices, the network-side devices comprising network-side antennas distributed over a plurality of positions within a radio cell, the method comprising:
transmitting a signaling message which requests a mobile station to transmit a response message, the signaling message being transmitted via at least one network-side antenna, the signaling message being transmitted to the mobile station and being used exclusively for requesting the response message;
receiving the response message from the mobile station, the response message being received by at least some of the network-side antennas; and
after receiving the response message, transmitting a user data message to the mobile station via a plurality of transmitting network-side antennas, the transmitting network-side antennas being selected from the plurality of network-side antennas based on which network-side antennas received the response message from the mobile station.

10. The method according to claim 9, wherein the signaling message is sent at regular time intervals.

11. The method in accordance with claim 9, wherein
the signaling message is transmitted only when a certain period of time elapsed since the last transmission of a message of the same type as the signaling message.

12. The method in accordance with claim 9, wherein
the signaling message is transmitted via all network-side antennas of the radio cell.

13. The method in accordance with claim 9, wherein
the radio communication system has a plurality of cells, each with a plurality of network-side antennas distributed therein, and
the signaling message is transmitted via all network-side antennas of all radio cells.

14. The method in accordance with claim 9, wherein
the signaling message is transmitted from a plurality of network-side antennas, and
the plurality of network-side antennas used to transmit the signaling message all belong to a same radio cell.

15. The method in accordance with claim 9, wherein
the signaling message is transmitted from a plurality of network-side antennas,
the radio communication system has a plurality of cells, each with a plurality of network-side antennas distributed therein, and
the plurality of network-side antennas used to transmit the signaling message reside in at least two different radio cells.

16. The method in accordance with claim 15, wherein
the signaling message identifies the radio cell in which the network-side antenna resides, and
the response message identifies the radio cell or radio cells from which the mobile station received the signaling message.

17. The method in accordance with claim 11, wherein
the signaling message is transmitted via all network-side antennas of the radio cell.

18. A network-side device in a radio communications system, which comprises network-side antennas distributed over a plurality of positions within a radio cell, the network-side device comprising:
means for receiving via at least some of the network-side antennas a response message from a mobile station or for receiving information about receipt of the response message from the mobile station, which response message was received via at least some of the network-side antennas, the response message being received in response to a signaling message sent to and received at the mobile station via at least one network-side antenna, the signaling message being transmitted exclusively for the purpose of requesting the response message;
means for choosing transmitting network-side antennas from the plurality of network-side antennas, the transmitting network-side antennas being chosen based on which network-side antennas received the response message from the mobile station; and
means for causing a user data message to be transmitted to the mobile station via the transmitting network-side antennas.

19. A computer readable medium storing a computer program for a network-side device in a radio communications system, which comprises network-side antennas distributed over a plurality of positions within a radio cell, the computer program comprising:
means for receiving information about receipt of a response message from a mobile station, the response message being received via at least some of the network-side antennas, the response message being received in response to a signaling message sent to and received at the mobile station via at least one network-side antenna, the signaling message being transmitted exclusively for the purpose of requesting the response message;
means for choosing transmitting network-side antennas from the plurality of network-side antennas, the transmitting network-side antennas being chosen based on which network-side antennas received the response message from the mobile station; and
means for causing a user data message to be transmitted to the mobile station via the transmitting network-side antennas.
